(19) United States
(12) Patent Application Publication
(10) Pub. No.: US 2009/0153998 A1
(43) Pub. Date: Jun. 18, 2009

(54) STORAGE MEDIUM REPRODUCING APPARATUS AND STORAGE MEDIUM REPRODUCING METHOD

(75) Inventors: Hiroaki Nakamura, Kanagawa (JP); Yasushi Tomizawa, Tokyo (JP); Shinji Takakura, Kanagawa (JP); Yoshiyuki Ishihara, Kanagawa (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/335,606

(22) Filed: Dec. 16, 2008

(30) Foreign Application Priority Data
Dec. 17, 2007 (JP) 2007-324942

(51) Int. Cl. G11B 20/10; G11B 5/596

(52) U.S. Cl. 360/39; 360/77.02; G9B/20.009; G9B/5.216

(57) ABSTRACT

A storage medium reproducing apparatus includes a storage medium that records data; a reproducing head that reads the data recorded in the storage medium; a positioning controlling unit that performs positioning control of the reproducing head with respect to tracks based on servo signals from the servo area included in the storage medium; and a reproducing processing unit that reproduces the data recorded in data area in the storage medium by reading recording dots of the data area using the reproducing head the position of which is decided on the tracks, wherein the reproducing head has a head width capable of simultaneously reading a plurality of servo dots.

### CROSS-REFERENCE TO RELATED APPLICATIONS

This application is based upon and claims the benefit of priority from the prior Japanese Patent Application No. 2007-324942, filed on Dec. 17, 2007; the entire contents of which are incorporated herein by reference.

### BACKGROUND OF THE INVENTION

1. Field of the Invention

The present invention relates to a storage medium reproducing apparatus and a storage medium reproducing method which use a storage medium that includes a data area having an arrangement of recording dots that are formed by mutually isolated recording materials.

2. Description of the Related Art

Due to significant enhancement of functions of a data device such as a personal computer (PC), data that is handled by a user has increased remarkably. Thus, a data recording and reproducing apparatus of a significantly high recording density is in ever increasing demand. Enhancing the recording density necessitates reduction of a size of a recording cell or a recording mark that is a writing unit of recording in a recording medium. However, reduction of the recording cell or the recording mark in the existing recording medium is extremely difficult.

For example, a polycrystal of a wide particle size distribution is used for a recording layer in a magnetic recording medium such as a hard disk. However, recording in a small polycrystal becomes unstable due to heat fluctuation of crystals. Thus, although recording in a large recording cell does not pose a drawback, recording in a small recording cell results in unstable recording and increased noise. Such drawbacks result due to a reduction in a number of crystal granules that are included in the recording cell and a relative increase in interaction between the recording cells.

A similar situation is observed in an optical recording medium that uses a phase change material. Recording becomes unstable and a medium noise increases at the recording density of greater than several hundred gigabytes per one square inch at which a recording mark size becomes nearly equal to a crystal size of the phase change material.

To avoid the drawbacks mentioned earlier, patterned media are suggested in the field of magnetic recording in which a recording material is prior divided using a nonrecording material and recording reproduction is carried out by treating a single recording material granule as a single recording cell.

A pattern forming method using photolithography or a method that forms a pattern by pressing a stamper that includes the pattern as a surface shape is used as a method to form a structure having isolated recording material granules.

However, a track density also increases along with the increase in the recording density and a servo mark for tracking also needs to be compatible with the track density. In a method that is disclosed in JP-A H6-111502 (KOKAI) as one of the methods for realizing a high track density, a servo pattern for tracking is prior built into a disk as a physical concavo-convex pattern. In the method, because originally a highly circular track is formed, the track density is enhanced compared to the existing hard disk drive (HDD).

For example, a servo format, disclosed in JP-A 2004-199806 (KOKAI), which uses a burst pattern that is used in a magnetic recording disk, is treated as the servo mark of the patterned media. Thus, a rectangular pattern, which is formed when the servo pattern is recorded using an existing recording head, is formed as the physical concavo-convex pattern. Due to this, the recording cells and the servo mark can be simultaneously formed. In the method mentioned earlier, the recording cells and the servo mark are formed on the same stamper and transferred onto the recording medium using a nanoimprint technology. A master is created on which the recording cells and the servo mark are simultaneously drawn using photolithography and the stamper is formed based on the master. A minute processing of several tens of nanometers (nm) is likely to be enabled using electron lithography or a focused ion beam.

In the servo mark that is transferred using an existing imprint, the rectangular pattern, which is formed by a servo track writer when recording on a disk medium using a recording head, is copied and the rectangular pattern is also formed on the stamper. Thus, an existing signal processing system can be utilized and a magnetic disk device with the patterned media can be manufactured by extending a conventional technology.

However, forming the servo mark of the rectangular pattern of a size that corresponds to the recording cells becomes difficult for a high recording density of 100 gigabits per square inch (Gbpsi) to 1 terabit per square inch (Tbpsi). When drawing on the master using electron lithography, along with a reduction in the size of the recording cells, the drawing becomes nearly circular in shape. Due to this, forming the rectangular servo mark used in the existing technology becomes difficult.

Accordingly, upon enhancement of the high recording density in the patterned media, the size of the servo mark is likely to become larger than the size of the recording cells. When transferring the recording cells and the servo mark as the physical concavo-convex pattern by the stamper, if the recording cells are small and the servo mark is large, a disparity occurs between servo areas included in the servo mark and data areas included in the recording cells in a contact area of the concavo-convex pattern of the stamper. Due to this, in a high track density, a highly precise pattern transfer using the stamper becomes difficult due to the disparity in the contact area. Thus, a variation in the shape of the recording cells increases error frequency and a variation in the shape of the servo mark reduces head positioning accuracy.

### SUMMARY OF THE INVENTION

According to one aspect of the present invention, a storage medium reproducing apparatus, includes a storage medium that records data; a reproducing head that reads the data recorded in the storage medium; a data area that is arranged on the storage medium, and includes tracks capable of writing data and recording dots formed by mutually isolated recording materials and arranged on the tracks; a servo area that is arranged on the storage medium, and includes servo dots on which position data for positioning the reproducing head is recorded, the servo dots being formed by mutually isolated recording materials having approximately the same size as the size of the recording dots; a positioning controlling unit that performs positioning control of the reproducing head with respect to the tracks based on servo signals from the servo area; and a reproducing processing unit that reproduces the data recorded in the data area by reading the recording dots of the data area using the reproducing head the position of which is decided on the tracks, wherein the reproducing head has a head width capable of simultaneously reading a plurality of servo dots.

According to another aspect of the present invention, a method of reproducing a storage medium, includes performing positioning control of a reproducing head with respect to tracks based on servo signals reproduced by the reproducing head from a servo area in the storage medium, the storage medium recording data, and including a data area having tracks capable of writing data and recording dots formed by mutually isolated recording materials and arranged on the tracks, and a servo area in which position data for deciding a position of the reproducing head is recorded and in which servo dots having approximately the same size as the size of the recording dots are formed by mutually isolated recording materials, the reproducing head having a head width capable of simultaneously reading a plurality of the servo dots; and reproducing the data recorded in the data area by reading the recording dots of the data area using the reproducing head that is positioned on the tracks.

### BRIEF DESCRIPTION OF THE DRAWINGS

FIG. 1 is a schematic diagram illustrating a structure of a hard disk according to a first embodiment of the present invention;

FIG. 2 is a schematic diagram for explaining a servo area and a data area that are shown in FIG. 1;

FIG. 3 is a block diagram illustrating a hard disk drive according to the first embodiment;

FIG. 4 is a flowchart of a reproducing process of data;

FIG. 5 is a schematic diagram illustrating a relation between a position of a reproducing head and servo signals that are reproduced;

FIG. 6 is a schematic diagram for explaining a signal process of the servo signals according to the first embodiment;

FIG. 7 is a schematic diagram for explaining a relation between the position of the reproducing head and a deviation detection value;

FIG. 8 is a schematic diagram for explaining a reproducing process of recording dots;

FIG. 9 is a schematic diagram for explaining reproduction of the recording dots when the position of the reproducing head is decided at a subtrack center; and

FIG. 10 is a schematic diagram illustrating a structure of a hard disk according to a second embodiment of the present invention.

### DETAILED DESCRIPTION OF THE INVENTION

Exemplary embodiments of the present invention are explained below with reference to the accompanying drawings. In the embodiments explained below, a storage medium reproducing apparatus according to the present invention is applied to a hard disk drive (HDD) that carries out recording and reproduction of data on a hard disk (HD).

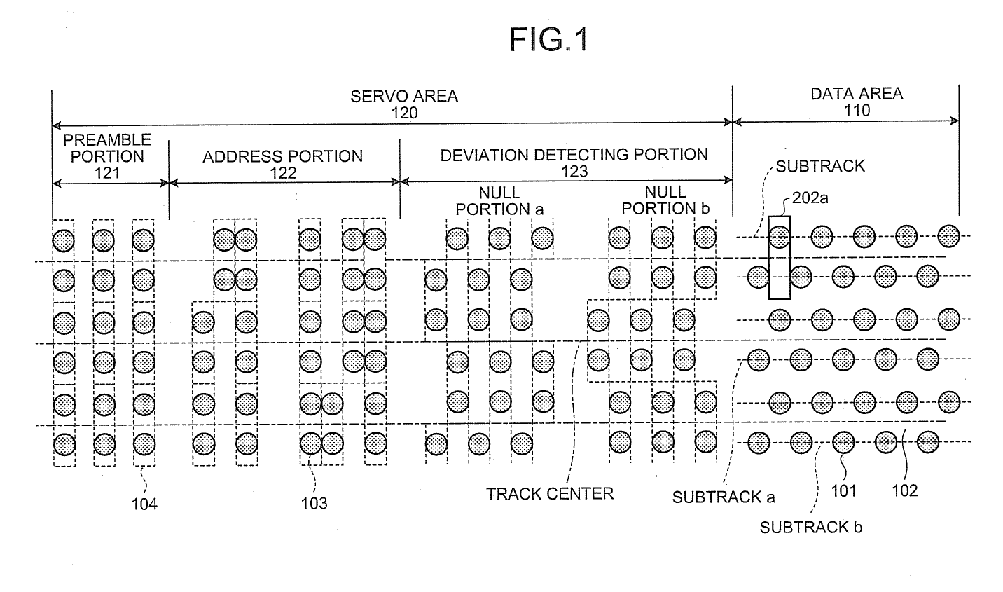

As shown in FIG. 1, a hard disk according to a first embodiment of the present invention concentrically includes a plurality of tracks and each track includes a plurality of sectors. A structure of three tracks and one sector is shown in FIG. 1. Each sector includes a data area 110 and a servo area 120.

The data area 110 is an area where data can be written. In the first embodiment, a plurality of recording dots 101 are mutually separated by a matrix 102 that is formed of a nonrecording material. Any material, which does not destroy the data that is written to the recording dots 101, can be used as a material of the matrix 102.

Magnetized data (bit data of “0” and “1”), which is read as reproduced signals, is recorded in the recording dots 101. The recording dots 101 are periodically arranged at a pitch P that is a first spacing along a direction in which a track extends, in other words, along a track direction (a horizontal direction shown in FIG. 1), thus forming subtracks. A single track includes a plurality of sequences of the subtracks. In the first embodiment, a single track includes two sequences of the subtracks (subtracks a and b). However, the present invention is not to be thus limited, and three or more subtracks can also be included in a single track.

If T indicates a track pitch, the subtracks are arranged at a distance of T/4 from a track center on both the sides.

Among the recording dots 101 of the subtrack a and the recording dots 101 of the subtrack b that are adjacent to each other within a single track, two proximal recording dots 101 are arranged such that a spacing, in the track direction, between the centers of the recording dots 101 is 1/n (however, 2=n=5) of the pitch P within the single subtrack a. As shown in FIG. 1, in the first embodiment, the recording dots 101 form a hexagonal minute packing structure that is the most stable structure, thus forming a triangular lattice. Due to this, the spacing, in the track direction, between the two proximal recording dots 101 on the adjacent subtracks is indicated by P/2 (in other words, n=2).

A shape of the recording dots 101 is desirably a circular shape, an oval shape, a rectangular shape, or a square shape that can be densely packed. A width of 5 to 100 nanometers (nm) is desirable for the recording dots 101 and a width of 10 to 50 nm is further desirable.

The hard disk, which is a magnetic storage medium, is used as a recording medium in the first embodiment. However, the present invention is not to be thus limited. For example, apart from the magnetic storage medium, various other storage media such as a phase change-optical recording medium, a ferroelectric medium, an electric charge-storage medium, a recording medium that includes an organic dye or a fluorescent compound can also be used as the recording medium. However, using the magnetic storage medium or the phase change-recording medium such as the hard disk according to the first embodiment is desirable. Using a perpendicular magnetic-recording medium, which can be highly densified, is further desirable.

The servo area 120 stores therein servo data that includes a track number and a sector number that are address data of the sector, synchronizing data, data of deviation detection of a head etc.

As shown in FIG. 1, similarly as servo data of an existing servo area, the servo area 120 further includes a preamble portion 121, an address portion 122, and a deviation detecting portion 123.

Data for synchronizing a reproduction clock with a disk pattern is recorded in the preamble portion 121. The preamble portion 121 is used for fixing a phase and a frequency of a read channel to a phase and a frequency of read signals respectively.

Cylinder data such as an address of a track and a sector is recorded in the form of a Manchester code in the address portion 122. The preamble portion 121 and the address portion 122 are patterns of a duty ratio of 50 percent that treat later explained servo dots 103 as “1” and treat a nonmagnetic area as “0”. The patterns mentioned earlier are similar to the patterns that are recorded by a normal servo track writer.

The deviation detecting portion 123 detects deviation detection values from the track center of the head and specifies a position of the head within the track.

As shown in FIG. 1, the servo dots 103, which are of the same shape and approximately the same size as the recording dots 101, are regularly arranged in the preamble portion 121, the address portion 122, and the deviation detecting portion 123 of the servo area 120. The servo dots 103 are mutually separated by the matrix 102 that is formed of the nonrecording material. The recording dots 101 and the servo dots 103 are desirably formed of the same material. Further, the matrix 102 is also desirably a nonrecording material that is similar to the nonrecording material that is used in the data area 110.

In existing technologies, servo data of the servo area is formed in a rectangular pattern. As shown in FIG. 1, a reference numeral 104 is indicated for comparing the existing rectangular pattern with the servo dots 103.

If the existing rectangular pattern is used as a servo pattern, a disparity occurs between a contact area of a stamper and the recording dots 101. Due to this, a stable pattern transfer using an imprint becomes difficult.

To overcome the drawback, in the first embodiment, the servo pattern of the servo area 120 is formed by a regular arrangement of the servo dots 103 that are of the same shape and approximately the same size as the recording dots 101. Thus, a stable pattern transfer using the imprint is enabled.

As shown in FIG. 1, in the servo pattern that uses the servo dots 103 according to the first embodiment, two servo dots are allotted with respect to one existing rectangular pattern 104. In the servo pattern that uses the servo dots 103, the servo dots 103 are arranged on both the sides from a pattern center at positions that are at a distance of one fourth of an existing servo pattern width T.

Further, in the hard disk according to the first embodiment, the servo dots 103 are arranged in the deviation detecting portion 123 such that a checker board shaped servo pattern is formed. The servo pattern in the deviation detecting portion 123 is a null type servo pattern in which magnetic polarity is repeated at a displacement of 180 degrees.

In other words, as shown in FIG. 1, the deviation detecting portion 123 includes a null portion a and a null portion b. The null portion a includes a servo pattern that is formed by the two servo dots 103 that are alternately arranged with respect to the track center at a spacing of the pitch P along the track direction. The null portion b includes a servo pattern that is formed by the two servo dots 103 that are alternately arranged with respect to the track center at a spacing of a pitch P/2 along the track direction.

The null portion a is a servo pattern for deviation detection in which a radial switching phase is delayed by 90° with respect to the null portion b. The null portion a is formed by two types of burst patterns. The area of the null portion a is used for detecting a deviated position of the head with respect to a centerline of the track.

In the first embodiment, a reproducing head 202a simultaneously reproduces at least two servo dots 103 and two recording dots 101. A head width of the reproducing head 202a is such that influence of the dots in the adjacent tracks is reduced.

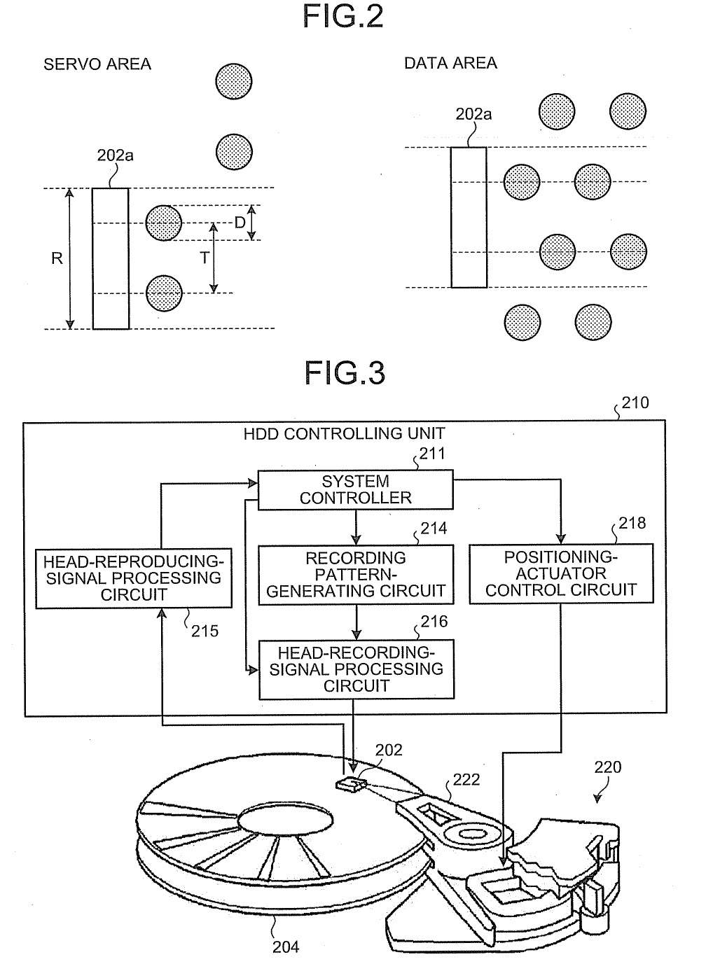

A relation between pattern diameters, pattern spacings, and the head width of the servo area 120 and the data area 110 is shown in FIG. 2. If T indicates a track pitch of the data area 110, D indicates a diameter of the servo dots 103 and the recording dots 101, and R indicates the head width of the reproducing head 202a, for ensuring reproduction of servo signals from the servo area 120 and reproduction of data signals from the data area 110, the head width of the reproducing head 202a needs to desirably satisfy relations that are indicated by the following expressions.

T=D*2

T+D=R=T+D*2

If the head width R is satisfying the expressions mentioned earlier, a distance relation becomes such that at least two servo dots 103 and at least two recording dots 101 enter within the head width of the reproducing head 202a, and the dots of the adjacent track are excluded. For increasing an amplitude of the reproduced signals and avoiding the influence of interference between adjacent tracks, the head width R needs to desirably be in a positional relation that satisfies the following expression.

R=T+D*2

A structure of the HDD according to the first embodiment is explained next. As shown in FIG. 3, the HDD according to the first embodiment includes an HD 204, a driving mechanism 220, and an HDD controlling unit 210. The driving mechanism 220 includes a magnetic head 202 and a suspension arm 222. The HDD controlling unit 210 is arranged as a control circuit on a printed circuit board inside the HDD. The reproducing head 202a is included in the magnetic head 202 along with a recording head (not shown).

As shown in FIG. 3, the HDD controlling unit 210 includes a system controller 211, a recording pattern-generating circuit 214, a positioning-actuator control circuit 218, a head-reproducing-signal processing circuit 215, and a head-recording-signal processing circuit 216 (recording unit).

The recording pattern-generating circuit 214 generates a recording pattern of data that is written to the HD 204. The positioning-actuator control circuit 218 decides positions of the reproducing head 202a and the recording head. Based on the deviation detection values that are detected by the deviation detecting portion 123, the positioning-actuator control circuit 218 calculates an off-track amount that is a displacement amount of the magnetic head 202 from the track center and moves the magnetic head 202 in the radial direction of the HD 204. The head-reproducing-signal processing circuit 215 receives the reproduced signals from the reproducing head 202a and transfers the reproduced signals to the system controller 211. The head-recording-signal processing circuit 216 causes the recording head to record in the HD 204, signals of the recording pattern that is generated by the recording pattern-generating circuit 214.

The system controller 211 controls the recording pattern-generating circuit 214, the positioning-actuator control circuit 218, the head-reproducing-signal processing circuit 215, and the head-recording-signal processing circuit 216.

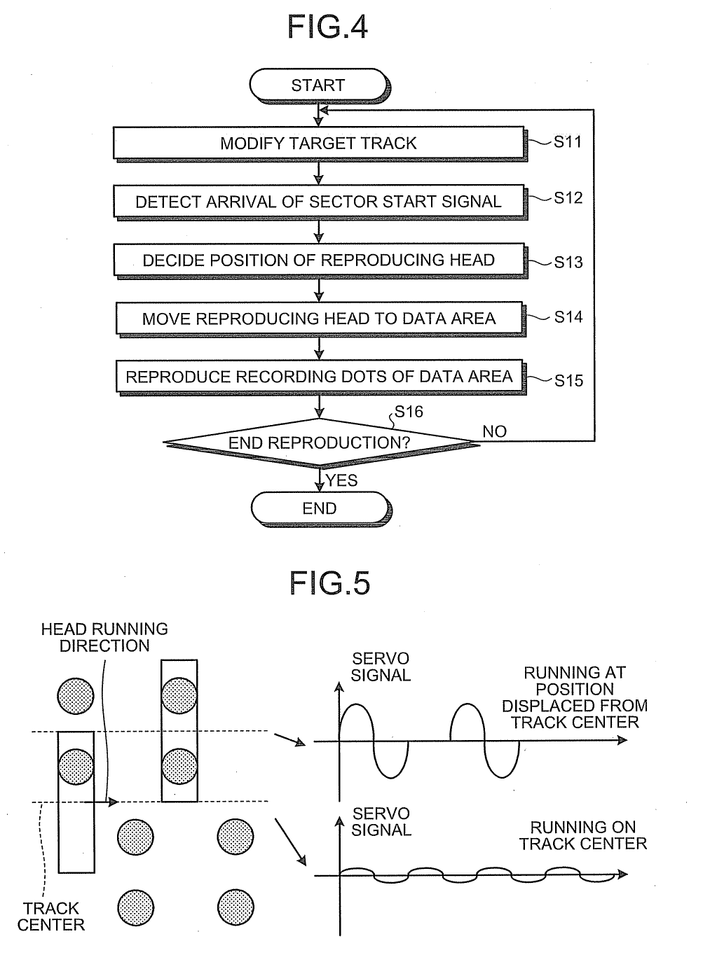

Next, a reproducing process of the data that is recorded on the HD 204 by the HDD according to the first embodiment is explained with reference to FIG. 4.

First, a target track is set for deciding a position of the reproducing head 202a (Step S11). Upon the system controller 211 receiving the arrival of a recording start sector (Step S12), the positioning-actuator control circuit 218 moves the reproducing head 202a to the servo area 120 and decides the position of the reproducing head 202a at the track center (Step S13).

Upon deciding the position of the reproducing head 202a at the track center, the positioning-actuator control circuit 218 moves the reproducing head 202a to the data area 110 (Step S14). Next, the reproducing head 202a reproduces the magnetic data of the recording dots 101 of the data area 110 (Step S15).

The process mentioned earlier is repeatedly executed until the system controller 211 receives an instruction to end reproduction (Step S16).

A position deciding process of the reproducing head 202a at Step S13 is explained in detail. First, a reproducing process of the servo data of the servo area 120, which is necessitated in the position deciding process, is explained in detail. A relation between a position of the reproducing head 202a with respect to the servo dots 103 according to the first embodiment and the reproduced servo signals is shown in FIG. 5.

When the reproducing head 202a is running on the track center, the reproducing head 202a detects a maximum of one servo dot 103. As shown in FIG. 5, the detected servo dot 103 becomes a servo signal (reproduced signal) of small amplitude. Because a sensitivity distribution of the reproducing head 202a is an attribute that generally includes a peak at the center of the head width R of the reproducing head 202a, a value of the actually reproduced servo signal is nearly equal to zero.

When the reproducing head 202a is running at a position that is displaced from the track center, the reproducing head 202a detects two servo dots 103. Due to this, as shown in FIG. 1, the reproduced servo signal becomes a servo signal of large amplitude.

Accordingly, when the reproducing head 202a is running at a position that is displaced from the track center, the deviation detection value appears as the size of the amplitude. The positioning-actuator control circuit 218 detects the deviation detection value of the reproducing head 202a by calculating the amplitude of the servo signal.

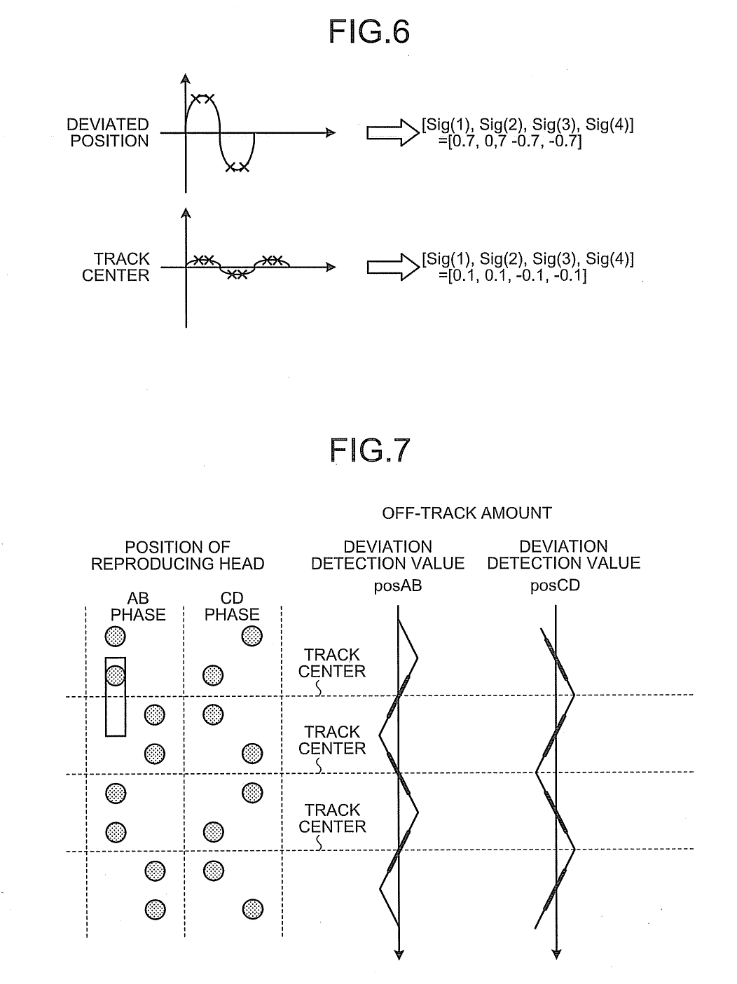

A signal process of the servo signals is explained next. FIG. 6 is a schematic diagram for explaining the signal process of the servo signals according to the first embodiment.

The head-reproducing-signal processing circuit 215 uses the synchronous clock for reproduction that is generated by the preamble portion 121 and carries out sampling at four points of a single wave from the servo signals of the null type servo pattern. For example, the head-reproducing-signal processing circuit 215 carries out sampling of values such as [Sig (1), Sig (2), Sig (3), Sig (4)]=[0.1, 0.1, −0.1, −0.1] at the track center and carries out sampling of values such as [Sig (1), Sig (2), Sig (3), Sig (4)]=[0.7, 0.7, −0.7, −0.7] at a position where the reproducing head 202a has deviated from the track center.

The positioning-actuator control circuit 218 retrieves the sampled amplitude detection values from the head-reproducing-signal processing circuit 215. Next, for detecting the deviation detection values from the track center, the positioning-actuator control circuit 218 multiplies each of the sampling values at the four points by a sine coefficient TBLSIN that is indicated in the following expression, and adds the multiplication values of the respective sampling value and the sine coefficient TBLSIN at the four points to calculate a deviation detection value posAB at that position.

TBLSIN=[1, 1, −1, −1]

For example, the positioning-actuator control circuit 218 calculates 0.4 as the deviation detection value posAB at the track center and 2.8 as the deviation detection value posAB at a deviation position that is displaced from the track center.

FIG. 7 is a schematic diagram for explaining a relation between a position of the reproducing head 202a in the null type servo pattern and the deviation detection values. In the null portion a of the deviation detecting portion 123, when the reproducing head 202a is positioned on the track center, the positioning-actuator control circuit 218 outputs the deviation detection value posAB that is nearly equal to zero. When the reproducing head 202a is at a position that is displaced from the track center, the positioning-actuator control circuit 218 outputs a large deviation detection value posAB.

In the null portion b, because the servo pattern is displaced by T/2 with respect to the servo pattern of the null portion a, when the reproducing head 202a is positioned on the track center, a deviation detection value posCD becomes the maximum, and when the reproducing head 202a is at a position that is displaced from the track center, the deviation detection value posCD is reduced.

In the null type servo pattern that includes the arrangement of the servo dots 103 according to the first embodiment, the servo dots 103 are circular shaped and include arc shaped edges. Due to this, a relation between the off-track amount, which is the actual displacement amount of the reproducing head 202a from the track center position, and the deviation detection values of the reproducing head 202a becomes nearly linear as indicated by a graph on the right that is shown in FIG. 7. Thus, the positioning-actuator control circuit 218 calculates the off-track amount of the reproducing head 202a by approximating the deviation detection values in a straight line.

Due to this, compared to calculating the off-track amount by using the existing rectangular servo pattern, linearity of the servo pattern is more suitable and a calculation precision of the off-track amount increases. Accordingly, in a portion where arc shaped edge servo signals of the servo dots 103 change, posAB and posCD are switched and used as the off-track amount. Thus, portions that constantly include good linearity can be used as the off-track amount.

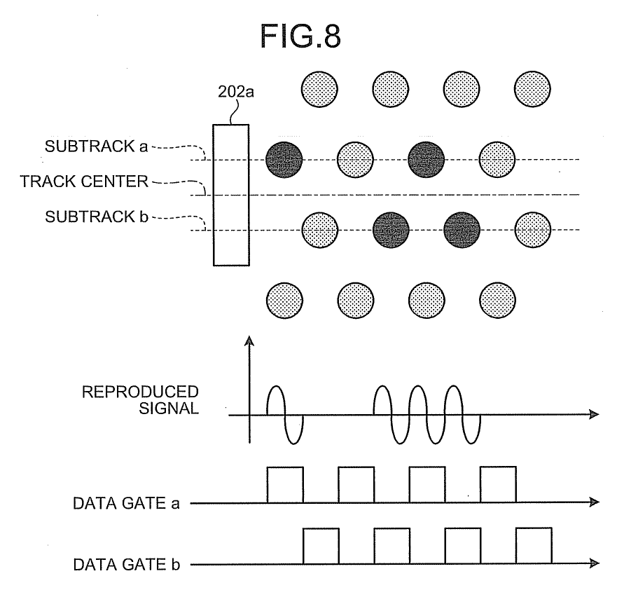

A reproducing process of the recording dots 101 of the data area 110 at Step S15 shown in FIG. 4 is explained next. FIG. 8 is a schematic diagram for explaining the reproducing process of the recording dots 101 according to the first embodiment. The positioning-actuator control circuit 218 calculates the off-track amount from the deviation detection values and decides (tracking) the position of the reproducing head 202a at the track center. As shown in FIG. 8, the reproducing head 202a, which is positioned at the track center, runs over the recording dots 101 on the data area 110 and reproduces the recording dots 101.

In the example shown in FIG. 8, black circles indicate the recording dots 101 that are magnetized, and circles other than the black circles indicate the recording dots 101 that are not magnetized. When the reproducing head 202a is positioned at the track center, the head-reproducing-signal processing circuit 215 causes the reproducing head 202a to read the recording dots 101 of two subtracks. During the reproduction of the recording dots 101, the magnetic data of the recording dots 101 of the two subtracks becomes reproduced signals that are read in a synthesized format.

The system controller 211 prior fixes a data gate a that is a time period for reproducing data that is recorded in the recording dots 101 of the subtrack a and a data gate b that is a time period for reproducing data that is recorded in the recording dots 101 of the subtrack b. Each data gate is transmitted from the system controller 211 to the head-reproducing-signal processing circuit 215. Due to this, the head-reproducing-signal processing circuit 215 can distinguish between the magnetized data of the recording dots 101 of the respective subtrack. In other words, when the position of the reproducing head 202a is decided at the track center, the head-reproducing-signal processing circuit 215 can reproduce bit data of the recording dots 101 of the two subtracks (in other words, the two recording dots 101) without deciding the position of the reproducing head 202a at the centers of the subtracks. The bit data, which is obtained from the recording dots 101 of the two subtracks, becomes the reproduced signals of a single track.

Further, the head-reproducing-signal processing circuit 215 can also reproduce the recording dots 101 when the position of the reproducing head 202a is decided at the centers of the subtracks.

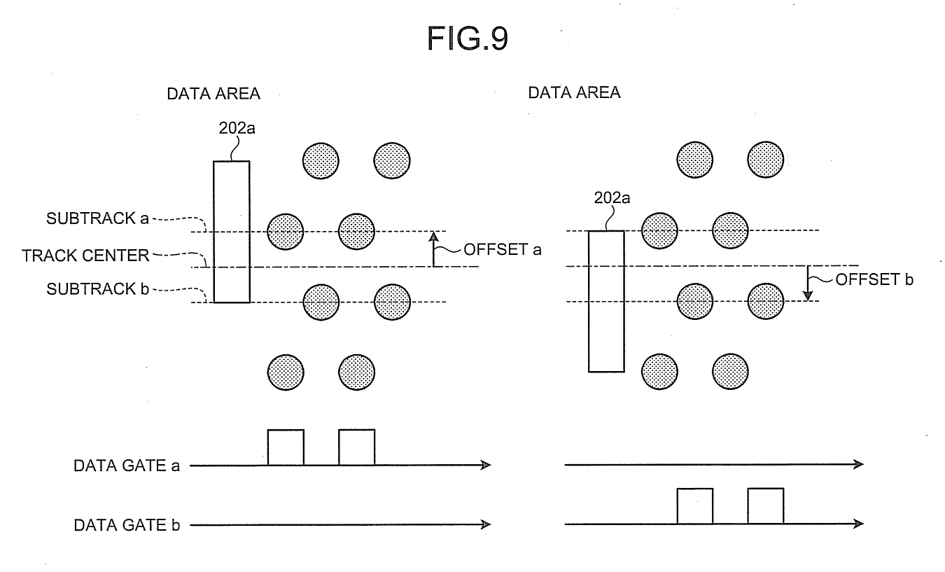

FIG. 9 is a schematic diagram for explaining the reproduction of the recording dots 101 when the position of the reproducing head 202a is decided at the centers of the subtracks according to the first embodiment. The sensitivity distribution of the reproducing head 202a is an attribute that generally includes a peak at the center of the head width R of the reproducing head 202a. For reading the magnetized data of the recording dots 101 at high sensitivity, matching of the center of the recording dots 101 and the center of the reproducing head 202a is desirable.

Thus, the positioning-actuator control circuit 218 decides the position of the reproducing head 202a at the centers of the subtracks, and causes the head-reproducing-signal processing circuit 215 to reproduce the recording dots 101.

For example, when reading the magnetized data of the recording dots 101 of the subtrack a, the positioning-actuator control circuit 218 decides the position of the reproducing head 202a at a position that is displaced by an offset a from the track center. Similarly, when reading the magnetized data of the recording dots 101 of the subtrack b, the positioning-actuator control circuit 218 decides the position of the reproducing head 202a at a position that is displaced by an offset b from the track center. Due to this, the head-reproducing-signal processing circuit 215 can retrieve the magnetized data of the recording dots 101 of the respective subtrack as the reproduced signals at a position where the sensitivity of the reproducing head 202a is the highest.

The reproducing head 202a is affected, although to a minor extent, by the magnetization data of the recording dots 101 of the adjacent subtrack. Due to this, the system controller 211 transmits the data gates a and b to the head-reproducing-signal processing circuit 215. If the head-reproducing-signal processing circuit 215, which receives the data gates a and b, has received the data gate corresponding to the target subtrack, the head-reproducing-signal processing circuit 215 can distinguish between the reproduced signals from the recording dots 101 of the target subtrack and other signals. For example, as shown in FIG. 9, when the reproducing head 202a is positioned at the center of the subtrack a and is reproducing the recording dots 101 of the subtrack a, during reception of the data gate a, the head-reproducing-signal processing circuit 215 invalidates the reproduced signals from the recording dots 101 of the subtrack b. Thus, the head-reproducing-signal processing circuit 215 can retrieve only the reproduced signals of the recording dots 101 of the target subtrack a.

In the HDD according to the first embodiment, because the servo pattern of the servo area 120 is formed by the data pattern of the same shape and approximately the same size as the recording dots 101 of the data area 110, concavo-convex contact areas of the stamper become the same in the servo area 120 and the data area 110. Due to this, according to the first embodiment, when transfer-forming the servo area 120 and the data area 110 using the same stamper in the manufacturing process of the HD 204, a stable transfer-forming is enabled. Thus, a variation in the shape of the recording dots 101 can be reduced and error frequency can be reduced. Further, according to the first embodiment, reducing a variation in the shape of the servo dots 103 enables to enhance a positioning accuracy of the magnetic head 202.

Further, in the HDD according to the first embodiment, the reproducing head 202a includes the distance relation which ensures the reproducing head width that enables to reproduce at least two servo dots 103 and two recording dots 101. Due to this, because a deviation from the track center is detected based on the reproduced signals of the dot shaped servo pattern, the off-track amount with respect to the displacement of the reproducing head 202a from the track center can be detected at positions of good linearity. Thus, positioning accuracy at the positions that are offset from the track center can be enhanced.

Further, in the HDD according to the first embodiment, the centers of the two proximal recording dots 101 inside the adjacent subtracks within a single track are separated by a spacing that is half of the recording pitch P along the track direction. During reproduction of the recording dots 101, the head-reproducing-signal processing circuit 215, which reproduces the recording dots 101 of each subtrack within a time period of the data gate corresponding to the respective subtrack, can distinguish between the recording dots 101 and the recording dots 101 of the other subtrack. Thus, according to the first embodiment, a recording density of the track can be enhanced.

Further, in the HDD according to the first embodiment, an offset position of the reproducing head 202a is decided at the respective subtrack center with respect to the two proximal recording dots 101 that are positioned on the adjacent subtracks within a single track. Due to this, the recording dots 101 within the respective subtracks can be reproduced at the positions where the sensitivity of the reproducing head 202a is the highest. Thus, according to the first embodiment, deterioration in the quality of signal reproduction can be prevented.

A second embodiment of the present invention is explained next. In the HD 204 of the HDD according to the first embodiment, the servo pattern of the deviation detecting portion 123 is checker board shaped. However, in the second embodiment, the servo pattern of a deviation detecting portion is a burst pattern.

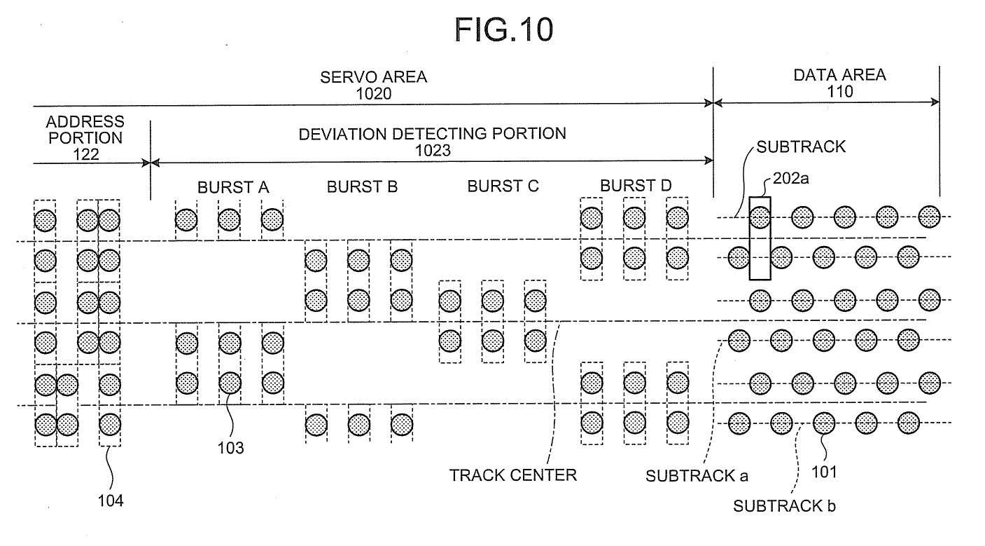

FIG. 10 is a schematic diagram illustrating a structure in an HD according to the second embodiment. A structure of the data area 110 according to the second embodiment is the same as the structure of the data area 110 according to the first embodiment.

A servo area 1020 according to the second embodiment includes a preamble portion (not shown), the address portion 122, and a deviation detecting portion 1023. The structure of the preamble portion and the address portion 122 is similar to the respective structure of the preamble portion 121 and the address portion 122 according to the first embodiment.

Similarly as in the first embodiment, the deviation detecting portion 1023 detects the deviation detection value of the reproducing head 202a from the track center and specifies the position of the reproducing head 202a within the track. However, in the second embodiment, the servo pattern of the servo dots 103 of the deviation detecting portion 1023 is a burst pattern that includes four phases as in the existing burst pattern. In other words, the burst pattern includes four areas of a burst A, a burst B, a burst C, and a burst D in which a pattern that is formed by two servo dots 103 is periodically arranged at a spacing of the pitch P along the track direction. The four areas of the burst A, the burst B, the burst C, and the burst D are arranged in the radial direction of the HD such that phases of the bursts A, B, C, and D are delayed.

To be specific, as shown in FIG. 10, the areas of the burst A and the burst B are symmetrically arranged with respect to the track center, and the areas of the burst C and the burst D are symmetrically arranged on the track center.

An existing method in which the deviation detection values are detected from a relative relation between the amplitudes of each burst can be used as a detecting method of the off-track amount of the reproducing head 202a that uses the deviation detecting portion 1023 that includes the burst pattern mentioned earlier.

The reproducing process of the recording dots 101 of the data area 110 is similar to the reproducing process according to the first embodiment.

Apart from effects that are similar to the first embodiment, in the HDD according to the second embodiment, because the deviation detecting portion 1023 of the HD is formed by the burst pattern, an existing position deciding method can be used. Thus, positioning accuracy can be enhanced while enhancing the efficiency of a position deciding control process.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A storage medium reproducing apparatus, comprising:
a storage medium that records data;
a reproducing head that reads the data recorded in the storage medium;
a data area that is arranged on the storage medium, and includes tracks capable of writing data and recording dots formed by mutually isolated recording materials and arranged on the tracks;
a servo area that is arranged on the storage medium, and includes servo dots on which position data for positioning the reproducing head is recorded, the servo dots being formed by mutually isolated recording materials having approximately the same size as the size of the recording dots;
a positioning controlling unit that performs positioning control of the reproducing head with respect to the tracks based on servo signals from the servo area; and
a reproducing processing unit that reproduces the data recorded in the data area by reading the recording dots of the data area using the reproducing head the position of which is decided on the tracks, wherein
the reproducing head has a head width capable of simultaneously reading a plurality of servo dots.

2. The apparatus according to claim 1, wherein
the tracks include, in the radial direction of the storage medium, a plurality of adjacent subtracks in which the recording dots are periodically arranged at a predetermined first spacing along a track direction that is a direction along which the tracks extend, and
the proximal recording dots of the two adjacent subtracks are arranged at a second spacing in which centers of the recording dots are at a distance of 1/n (n is an integer of 2=n=5) of the first spacing from each other along the track direction.

3. The apparatus according to claim 2, wherein
the servo area includes a preamble portion in which data for synchronizing a clock of reproduced signals is recorded, an address portion in which data of a cylinder is recorded, and a deviation detecting portion wherein data for detecting an off-track amount of a magnetic head is recorded, and
the data of the preamble portion, the address portion, and the deviation detecting portion are periodically arranged in the servo dots at the first spacing coaxially with the subtracks.

4. The apparatus according to claim 3, wherein the reproducing head has the head width that enables to simultaneously reproduce at least two recording dots and at least two servo dots.

5. The apparatus according to claim 3, wherein the positioning controlling unit extracts sample data of one period from the servo signals obtained from the deviation detecting portion, multiplies each of the sample data by a coefficient based on a synchronizing clock, detects a position displacement of the magnetic head based on a sum of multiplication values with respect to all the sample data, and performs positioning control of the reproducing head with respect to the tracks.

6. The apparatus according to claim 3, wherein the deviation detecting portion includes a first area in which a pattern is arranged that is formed by the two servo dots that are alternately arranged with respect to a track center at the first spacing along the track direction, and a second area in which the pattern is alternately arranged on the track center at the second spacing along the track direction.

7. The apparatus according to claim 3, wherein the deviation detecting portion includes a plurality of burst portions in which a pattern formed by the two servo dots is periodically arranged at the first spacing along the track direction, and
the burst portions are arranged along the radial direction of a magnetic recording medium such that phases of the burst portions are shifted.

8. The apparatus according to claim 3, wherein the positioning controlling unit decides the position of the reproducing head at the track center, and
the reproducing processing unit reproduces the recording dots of the two adjacent subtracks by the reproducing head the position of which is decided at the track center.

9. The apparatus according to claim 8, wherein the reproducing processing unit switches, for each of the subtracks, a reproduction period that is a time period in which the data recorded in the recording dots that are arranged in the subtracks is reproduced, and reproduces the recording dots of the subtrack corresponding to the reproduction period.

10. The apparatus according to claim 9, wherein the positioning controlling unit decides the position of the reproducing head at centers of the subtracks, and
the reproducing processing unit switches the reproduction period for each of the subtracks, and reproduces, during the reproduction period, the recording dots of the subtrack corresponding to the reproduction period.

11. A method of reproducing a storage medium, comprising:
performing positioning control of a reproducing head with respect to tracks based on servo signals reproduced by the reproducing head from a servo area in the storage medium, the storage medium recording data, and including a data area having tracks capable of writing data and recording dots formed by mutually isolated recording materials and arranged on the tracks, and a servo area in which position data for deciding a position of the reproducing head is recorded and in which servo dots having approximately the same size as the size of the recording dots are formed by mutually isolated recording materials, the reproducing head having a head width capable of simultaneously reading a plurality of the servo dots; and
reproducing the data recorded in the data area by reading the recording dots of the data area using the reproducing head that is positioned on the tracks.
